(19) United States
(12) Patent Application Publication
(10) Pub. No.: US 2006/0176930 A1
(43) Pub. Date: Aug. 10, 2006

(54) Method for measuring temperature in microscale

(76) Inventors: Jung Yul Yoo, Seoul (KR); Woon Seop Jung, Gyeonggi-do (KR); Sung Wook Kim, Gyeonggi-do (KR)

Correspondence Address: DICKSTEIN SHAPIRO MORIN & OSHINSKY LLP, 2101 L Street, NW, Washington, DC, 20037, US

(21) Appl. No.: 11/050,862

(22) Filed: Feb. 7, 2005

(51) Int. Cl. G01J 5/00

(52) U.S. Cl. 374/121

(57) ABSTRACT

A temperature measuring method has the steps of (a) coating a mixture of fluorescent dye on a surface of the micro device, (b) heating the micro device with a calibration heater, (c) acquiring an emission intensity image of the mixture with a camera by illuminating the surface of the micro device with a light, (d) averaging the emission intensity image by units of a plurality of pixels, (e) calculating a temperature calibration curve indicating a change of the emission intensity with respect to the temperature, from the image averaged by units of a plurality of pixels, and (f) removing the calibration heater, acquiring an emission intensity image by actually driving the micro device, and converting the acquired emission intensity image into a temperature, using the temperature calibration curve. According to the method, the temperature calibration curve is obtained through the averaged emission intensity image, and a temperature field on the micro device is measured using the temperature calibration curve. Thus, the emission intensity of fluorescent dye can correct a deviation occurring between each pixel of the image, thereby making it possible to precisely measure the temperature field in microscale.

### BACKGROUND OF THE INVENTION

1. Field of the Invention

The present invention relates to a method for measuring a temperature in microscale, and more particularly to a temperature measuring method capable of precisely measuring a whole-field temperature on a micro device surface using a temperature sensitive fluorescent dye.

2. Description of the Related Art

An accurate temperature measurement in microscale is required to develop diverse micro devices such as a micro reactor, a micro cooler, a micro heater, a polymerase chain reaction chip, and a μTAS (micro Total Analysis System), etc.

Methods for measuring a temperature in microscale can be largely classified into contact and non-contact ones.

The contact measuring method measures a temperature by directly contacting a resistance thermometer and a thermocouple, etc. to a micro device. The thermocouple is widely used since it has a good interchangeability and covers a wide range of temperature. The resistance thermometer is applied to, for example, a e pump, a polymerase chain reaction chip, etc. However, since the thermocouple and the resistance thermometer can cause flow fluctuation and measure temperatures only at specified points, they have a limitation in measuring a whole-field temperature in microscale.

The non-contact measuring method comprises, for example, a thermochromic liquid crystal method and a laser induced fluorescence method.

The thermochromic liquid crystal method measures the temperature on a micro device surface using a thermochromic liquid crystal and has been used to measure the temperature of a polymerase chain reaction chip, an electronic part, etc. However, this method has a difficulty in performing a precise temperature measurement in microscale since the thermochromic liquid crystal has a size as large as 10 μm.

The laser induced fluorescence method uses a principle that emission intensity of the fluorescent dye changes according to the temperature. According to this method, a temperature field is calculated by dissolving the fluorescent dye in the fluid to be measured, irradiating the measuring object with a laser and thus measuring the emission intensity of the fluorescent dye. The emission intensity of the fluorescent dye decreases as the temperature increases. Accordingly, it is possible to measure a temperature field of an object by measuring the emission intensity. Many studies on temperature measurements in macroscale using such laser induced fluorescence method have been recently carried out. Rhodamine B is generally used as the fluorescent dye since rhodamine B has a relatively large change rate of the emission intensity like as −1.5˜−3%/K.

However, the conventional laser induced fluorescence method has various technical problems to be considered, such as non-uniform concentration distribution of the fluorescent dye at the temperature measurement area, photobleaching phenomenon, shadowgraph effect, intensity variation of the light source, etc.

In order to solve these problems of the laser induced fluorescence method, two-color laser induced fluorescence method, which uses both rhodamine B dye sensitive to temperature and rhodamine 110 dye insensitive to temperature, is also adopted. In this method, the temperature is measured by the ratio of emission intensities of rhodamine B and rhodamine 110. However, the two-color laser induced fluorescence method has a problem that the emission wavelengths of the two fluorescent dyes are overlapped, although it can solve the above problems such as intensity variation of the light source, non-uniform concentration distribution of the dye, etc.

### SUMMARY OF THE INVENTION

Accordingly, the present invention has been made to solve the above-mentioned problems occurring in the prior art. The objective of the present invention is to provide a method for measuring the temperature in microscale, which is capable of precisely measuring a temperature field on a micro device surface using a temperature sensitive fluorescent dye.

In order to accomplish the objective, a temperature measuring method is provided for measuring a temperature field on a micro device surface, comprising steps of: (a) coating a mixture of fluorescent dye on a surface of the micro device, (b) heating the micro device with a calibration heater, (c) acquiring an emission intensity image of the mixture with a camera by illuminating the surface of the micro device with a light, (d) averaging the emission intensity image by units of a plurality of pixels, (e) calculating a temperature calibration curve indicating the variation of emission intensity with temperature, from the image averaged by units of a plurality of pixels, and (f) removing the calibration heater, acquiring an emission intensity image by actually driving the micro device, and converting the acquired emission intensity image into a temperature using the temperature calibration curve.

According to the above method, since the emission intensity of the fluorescent dye can correct a deviation occurring between each of the pixels of the image by calculating a temperature calibration curve from the averaged emission intensity image and measuring a temperature field of the micro device using the temperature calibration curve, it is possible to accurately measure a temperature field in microscale.

According to an embodiment of the invention, the method may further comprise a step of acquiring a plurality of the emission intensity images at every specific temperature and averaging them, between the steps (c) and (d), in order to minimize an error of the temperature measurement. At this time, it is preferred to average 200 images at every specific temperature.

In addition, in the step (d), the emission intensity image can be averaged by units of 5×5 pixels. By averaging the image by units of 5×5 pixels, it is possible to precisely measure the temperature field without reducing the spatial resolution.

Additionally, according to an embodiment of the invention, the method may further comprise a step of dividing the image averaged by units of a plurality of pixels by an emission intensity image obtained at room temperature, between the steps (d) and (e).

Meanwhile, the mixture of fluorescent dye coated on the surface of the micro device may consist of fluorescent dye, photoresist, thinner, and acetone. Rhodamine B can be used as the fluorescent dye and SU8 photoresist can be used as the photoresist. More specifically, composition of the mixture may consist of about 0.01 g of rhodamine B, about 5 ml of SU8 photoresist, about 2.5 ml of thinner and about 10 ml of acetone. In this composition ratio, the difference in the emission intensities of the fluorescent dye according to the temperature change is maximized.

Meanwhile, the step (f) may be subdivided into steps of (g) acquiring the emission intensity image of the fluorescent dye mixture according to the actual operation of the micro device, (h) averaging the image obtained from the step (g) by units of a plurality of pixels, (i) dividing the image obtained from the step (h) by an emission intensity image at room temperature, and (j) calculating the emission intensity from the image obtained in the step (i) and converting the calculated emission intensity into a temperature using the calibration curve.

Similarly to the calculation of the temperature calibration curve, in the step (h), the image obtained from the step (g) can be averaged by units of 5×5 pixels.

### BRIEF DESCRIPTION OF THE DRAWINGS

The above and other objectives, features and advantages of the present invention will be more apparent from the following detailed description given in conjunction with the accompanying drawings, in which:

FIG. 1 is a plan view of an exemplary micro heater to which the invention is applied;

FIG. 2 is a schematic view showing a structure of a temperature measuring apparatus for performing a temperature measuring method according to an embodiment of the invention;

FIG. 3 is a flow chart showing a temperature calibration procedure of a temperature measuring method according to an embodiment of the invention;

FIGS. 4A and 4B are emission intensity images of fluorescent dye at a specific temperature, which are obtained from a temperature calibration procedure;

FIGS. 5A and 5B are images obtained by averaging the images of FIGS. 4A and 4B by units of 5×5 pixels;

FIG. 6 is an image obtained by dividing the image of FIG. 5A by an emission intensity image at room temperature;

FIG. 7 is a graph of a temperature calibration curve obtained from a temperature calibration procedure;

FIG. 8A is an emission intensity image obtained under a state that the micro heater shown in FIG. 1 is operated;

FIG. 8B is an image obtained by dividing the image of FIG. 8A by an emission intensity image at room temperature;

FIG. 9 is a sequence of images showing a change of temperature field on the surface of the micro heater of FIG. 1, as time goes by; and

FIGS. 10A and 10B are graphs showing standard deviations of emission intensities as temperature changes, which are obtained by using a temperature calibration curve.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

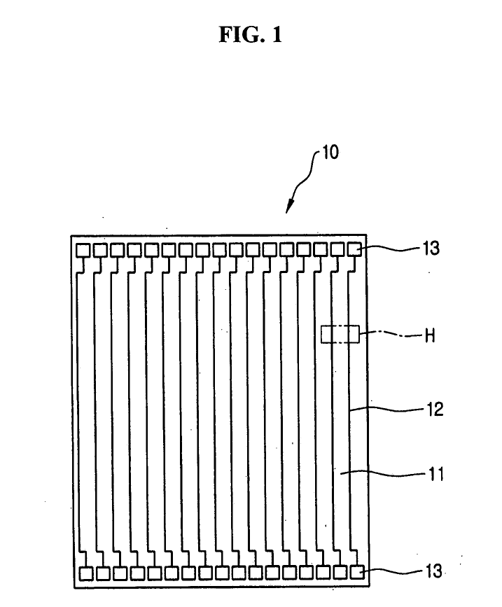

FIG. 1 is a plan view of a micro heater to which the present invention is applied. As shown in FIG. 1, the micro heater 10 comprises a substrate 11, a plurality of metallic heating wires 12 regularly arranged at a predetermined spatial interval on the substrate 11, and contact pads 13 formed on both ends of each heating wire 12. The micro heater 10 is fabricated according to a manufacturing process of a semiconductor. A glass wafer or silicon wafer can be used as the substrate 11. According to a preferred embodiment of the invention, a line width of the heating wire 12 is 10 μm.

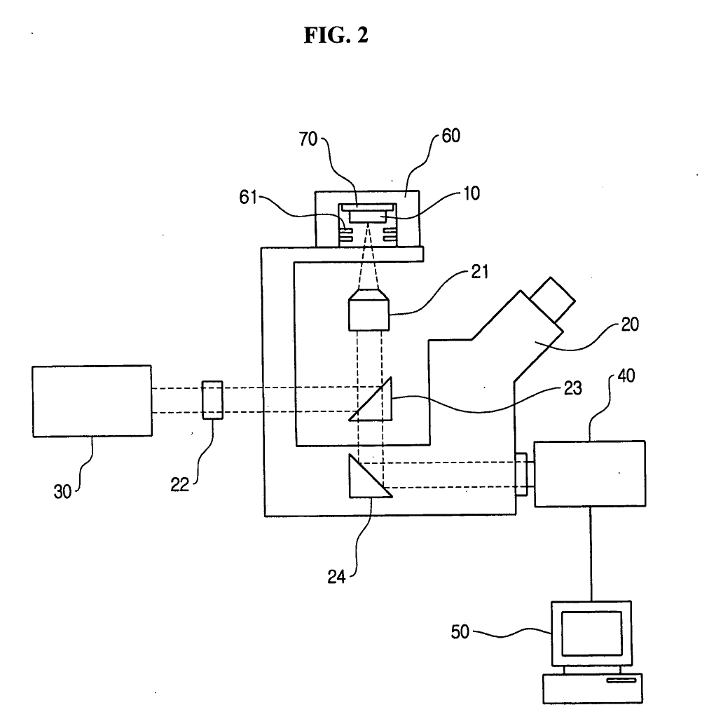

FIG. 2 is a schematic view showing a structure of a temperature measuring apparatus for performing a temperature measuring method according to an embodiment of the invention. As shown in FIG. 2, the temperature measuring apparatus comprises a fluorescence microscope 20 having a 10× objective lens 21, a light source 30 for illuminating a surface of the micro heater 10 coated with fluorescent dye, a CCD camera 40 for acquiring a fluorescence image of the micro heater 10, and a personal computer 50 storing the image acquired by the camera 40. According to an embodiment of the invention, a mercury lamp or Ar-ion laser may be used as the light source 30.

An adiabatic chamber 60 is mounted on the upper part of the objective lens 21 and the micro heater 10 is installed in the adiabatic chamber 60 so that one side of the micro heater 10 faces the objective lens 21. In addition, the other side of the micro heater 10 is in contact with a calibration heater 70 for performing a temperature calibration.

The adiabatic chamber 60 and the calibration heater 70 are provided to obtain a calibration curve which will be described later and are to be removed when measuring an actual temperature field of the micro heater 10. According to an embodiment of the invention, a flat-plate silicon heater may be used as the calibration heater 70.

In FIG. 2, a reference numeral 61 indicates a thermocouple for measuring the temperature inside the adiabatic chamber 60. The temperature of the calibration heater 70 may be regulated according to a measurement result of the thermocouple 61.

In the temperature measuring apparatus having a structure as described above, light emitted from the light source 30 passes through a neutral density filter 22 for reducing the amount of light from the light source and preventing a decomposition of the fluorescent dye. Then it is refracted at 90° from the traveling direction by a first dichroic mirror 23 and it becomes an incident light on the surface of the micro heater 10 through the objective lens 21. The light reflecting from the surface of the micro heater 10 passes through the objective lens 21, is refracted at 90° from the traveling direction by a second dichroic mirror 24, and then enters the camera 40. Accordingly, a fluorescence image caused by the fluorescent dye coated on the surface of the micro heater 10 is acquired by the camera 40.

The invention measures a temperature field of the micro heater 10 using a principle that emission intensity of the fluorescent dye changes according to the temperature. The emission intensity of the fluorescent dye is a function of the temperature and is expressed as follows:
I(T)=I₀εCΦ(T),

where I is the emission intensity of the fluorescent dye, I₀ is the intensity of the light source, ε is the molar absorption, C is the concentration of the fluorescent dye, and Φ is the quantum efficiency. Since the quantum efficiency (Φ) of the fluorescent dye decreases as the temperature increases, the emission intensity (I) also decreases. In other words, the emission intensity of the fluorescent dye is inversely proportional to the temperature.

According to an embodiment of the invention, a mixture of the fluorescent dye and other additives is coated on the surface of the micro heater 10. As the mixture of the fluorescent dye, a mixture in which rhodamine B as the fluorescent dye, SU8 photoresist, SU8 thinner, and acetone are mixed, is used. The SU8 photoresist is used to set the fluorescent dye on the surface of the micro heater 10, the acetone is used as a solvent for dissolving the rhodamine B and the SU8 photoresist, and the thinner is used to regulate the coating thickness. According to an embodiment of the invention, the coating thickness of the fluorescent dye mixture is about 1 μm.

Preferably, the mixture has a composition ratio making the largest difference in the emission intensities of the fluorescent dye according to the temperature change, i.e., the composition ratio that is most sensitive to the temperature change. According to the experimental results for diverse mixing ratios of fluorescent dye mixture, it is known that when amounts of the SU8 photoresist, SU8 thinner, acetone, and rhodamine B are, respectively, 5 ml, 2.5 ml, 10 ml, and 0.01 g in a temperature range between the room temperature of 25.6° C. and 91.6° C., the difference of the emission intensities of the fluorescent dye was maximized.

Hereinafter, a temperature measuring method using the above temperature measuring apparatus will be described in detail. The temperature measuring method of the invention can be divided into a temperature calibration process using the calibration heater 70 and a temperature field measuring process with an actual operation of the micro heater 10.

(Temperature Calibration Process)

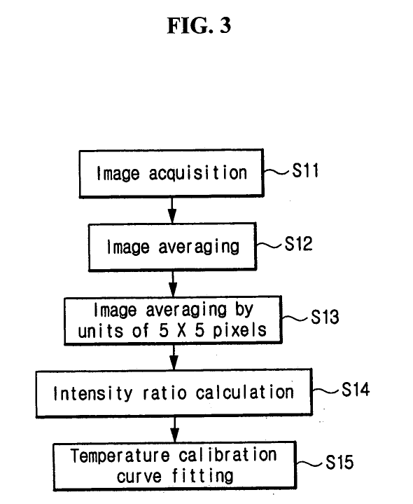

Firstly, as shown in FIG. 3, an emission intensity image of the fluorescent dye coated on the surface of the micro heater 10 is continuously acquired by the camera 40 while regulating the temperature of the calibration heater 70 (S11). The camera 40 takes photographs of 200 emission intensity images at each temperature and the acquired images are stored in the computer 50.

Then, the computer 50 averages the 200 emission intensity images and produces an averaged image (S12). A method of averaging the 200 emission intensity images may comprise steps of digitizing light and darkness of an image and averaging the digitized light and darkness.

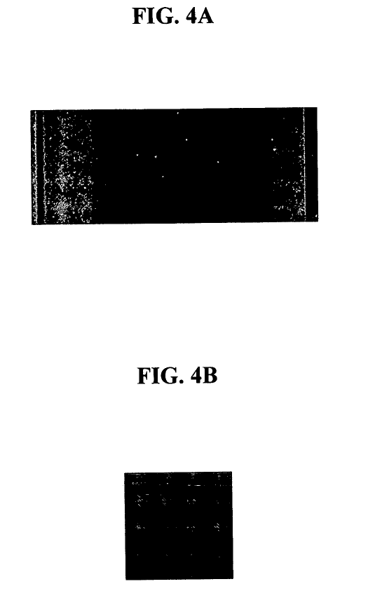

FIG. 4A shows the averaged image at a specific temperature and FIG. 4B is an enlarged view of a part corresponding to a unit of 5×5 pixels in FIG. 4A. The images of FIGS. 4A and 4B correspond to “H” part in FIG. 1.

According to the embodiment, the size of one pixel is 0.67 μm×0.67 μm. As shown in FIG. 4B, there is a difference in the emission intensities of respective pixels even in the image obtained at a single temperature. When performing a temperature calibration under such a state, an error occurs in measuring the temperature field.

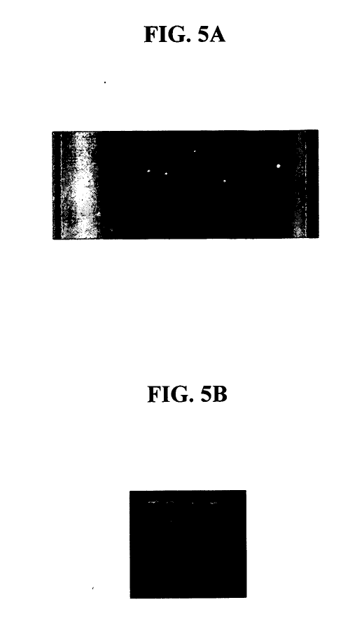

In order to solve this problem, the averaged image of FIG. 4A is again averaged by units of 5×5 pixels (S13). FIG. 5A shows an image obtained by averaging the image of FIG. 4A by units of 5×5 pixels, and FIG. 5B is an enlarged view of a part corresponding to a unit of 5×5 pixels in FIG. 5A. Naturally, as shown in FIG. 5B, there is no difference in emission intensities of respective pixels in the image averaged by units of 5×5 pixels. Thus, it is possible to reduce temperature fluctuation between adjacent pixels with such image processing.

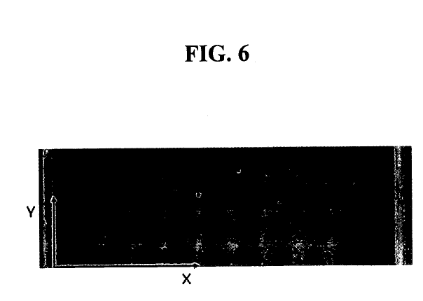

Then, an intensity ratio image as shown in FIG. 6 is obtained by dividing the emission intensity image at a specific temperature in FIG. 5A by an emission intensity image at room temperature (S14). The image of FIG. 6 can be obtained at each specific temperature.

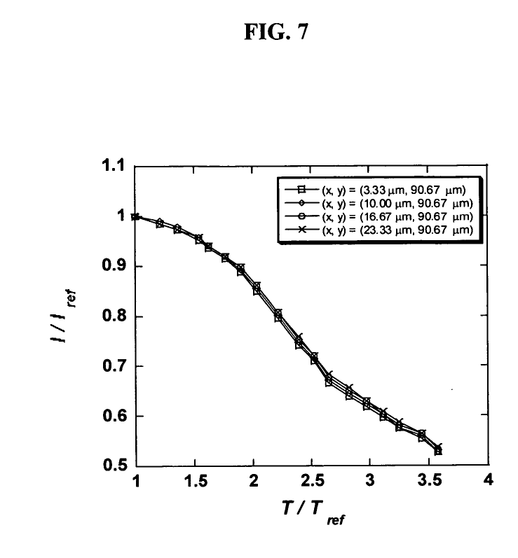

A temperature calibration polynomial indicating the variation of emission intensity with temperature is calculated from the image of FIG. 6, and a temperature calibration curve as shown in FIG. 7 is obtained as a result of this calculation (S15). In FIG. 7, T/T_{ref} on the abscissa indicates the ratio of a specific temperature (T) to a reference temperature (T_{ref}), i.e., room temperature, and I/I_{ref} on the ordinate indicates the ratio of the emission intensity (I) at a specific temperature to the emission intensity (I_{ref}) at room temperature.

Meanwhile, as shown in FIG. 5A, the measured emission intensity is different according to a local area even when the micro heater 10 has a uniform temperature at all areas. This is because the incident light is non-uniformly reflected on the surface of the micro heater 10 and the fluorescent dye is not completely uniformly coated on the surface of the micro heater 10.

Accordingly, in the invention, the non-uniformity of the emission intensities at measured areas is corrected by performing a temperature calibration for respective pixels, which obtains a temperature calibration polynomial for all pixels (i.e., all points on the surface of the micro heater). FIG. 7 shows a temperature calibration curve at any four points on the surface of the micro heater 10. Since the curve exhibits a characteristic of a cubic equation, a cubic polynomial calibration curve was used.

(Temperature-Field Measuring Procedure)

When the temperature calibration curve as shown in FIG. 7 is obtained through the temperature calibration procedure, a temperature field on the surface of the micro heater 10 is measured by actually driving the micro heater 10.

When measuring the temperature field, the adiabatic chamber 60 and the calibration heater 70 are removed from the measuring apparatus shown in FIG. 2, and then a DC power supply (not shown) is connected to the contact pads (13) of the micro heater 10 so that electric current passes through the heating wires 12 and thus the micro heater 10 is operated to generate heat.

After an emission intensity image is obtained while locally operating the micro heater 10, an averaged image is obtained by averaging the emission intensity images by units of 5×5 pixels and then an intensity ratio image is obtained by dividing the averaged image by the emission intensity at room temperature.

The emission intensity of the micro heater 10, represented in the form of intensity ratio image, can be converted into the temperature by the temperature calibration curve (FIG. 7) obtained from the temperature calibration procedure. It is possible to measure the temperature field on the surface of the micro heater 10 by converting the emission intensity of the micro heater 10 into the temperature using the temperature calibration curve.

As described above, according to the embodiment, the size of one pixel is 0.67 μm×0.67 μm, so that the spatial resolution of the temperature measuring method of the invention is 3.35 μm×3.35 μm corresponding to the size of 5×5 pixels. Accordingly, it is possible to accurately measure the temperature field in microscale.

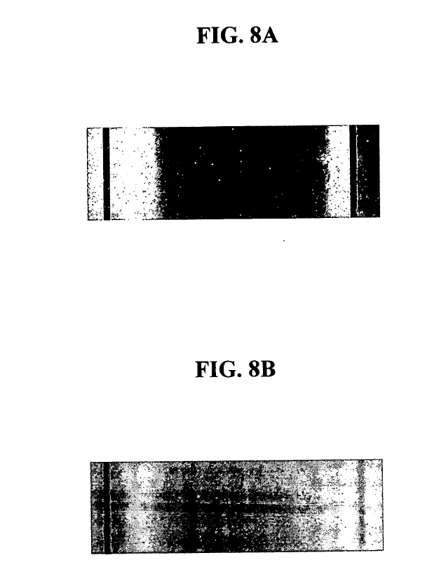

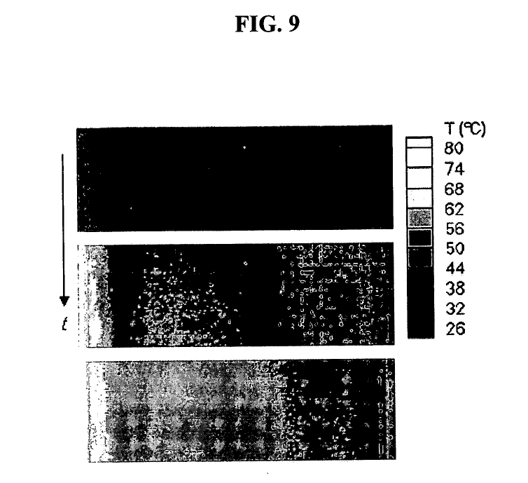

FIG. 8A shows a fluorescence emission intensity image when left heating wire 12 only is operated in “H” part of the micro heater 10 of FIG. 1, and FIG. 8B shows an intensity ratio image obtained by averaging the image of FIG. 8A by units of 5×5 pixels and then dividing the averaged image by the emission intensity at room temperature. It is also noted that FIGS. 8A and 8B illustrate the experimental results of the micro heater 10 having the substrate 11 made of glass.

As shown in FIG. 8A, in the original emission intensity image, there is little difference between the emission intensity above the left heating wire 12 being operated and the emission intensity above the right heating wire 12 not being operated. However, as shown in FIG. 8B, in the intensity ratio image, it can be seen that the intensity ratio above the left heating wire 12 is smaller than the intensity ratio above the right heating wire 12. That is, it is possible to more clearly recognize the temperature change on the surface of the micro heater 10 through the intensity ratio image of FIG. 8B.

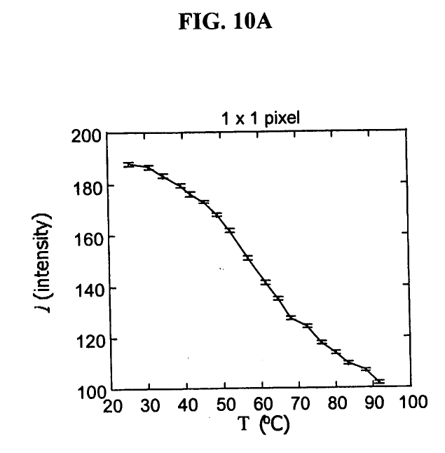

FIG. 9 is a sequence of images of the temperature field measured at intervals of 2.67-seconds, after temperature calibration for respective pixels is performed according to an embodiment of the invention. As shown in FIG. 9, in the image of the temperature field measured after performing temperature calibration for respective pixels, the temperature rises instantaneously up to 80° C. just above the heating wire 12 being operated. However, the temperature decreases as we move farther away from the heating wire 12, and the temperature gradient in the spanwise direction along the horizontal axis also decreases.

Meanwhile, as described above with reference to FIG. 4B, it can be seen that there was a difference in the emission intensities between each pixel (0.67 μm×0.67 μm) of the image even at a uniform temperature. This is because it is difficult to uniformly coat the fluorescent dye in the range of 0.67 μm×0.67 μm and the incident light is non-uniformly reflected on the heater surface. According to the invention, in order to reduce the difference in the emission intensities between each pixel, the image is averaged by units of 5×5 pixels as shown in FIGS. 5A and 5B.

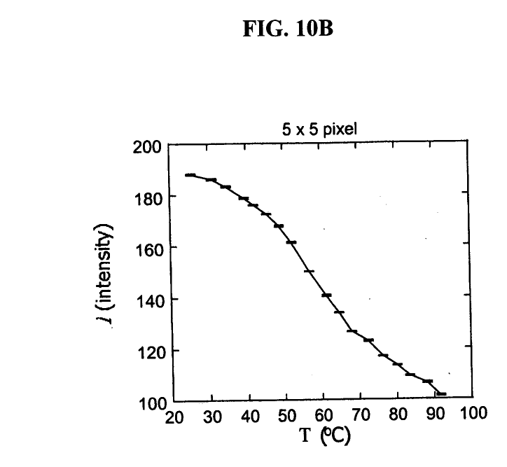

FIGS. 10A and 10B are graphs showing standard deviations of the emission intensities with respect to temperature, obtained by using temperature calibration curves at any points on the surface of the micro heater. FIG. 10A is a graph when the temperature calibration is performed by units of 1×1 pixel, and FIG. 10B is a graph when the temperature calibration is performed by units of 5×5 pixels. In FIGS. 10A and 10B, 200 images per temperature were obtained, and population mean and population standard deviation were calculated with 95% confidence interval.

As shown in FIG. 10A, when the temperature calibration curve is obtained by the image averaged by units of 1×1 pixel, a spatial resolution is 0.67 μm×0.67 μm, a standard deviation of the temperature is ±1.76° C. and a standard deviation of the emission intensity, which is graded between 0 and 255, is ±2.55. In contrast with this, as shown in FIG. 10B, when the temperature calibration curve is obtained by the image averaged by units of 5×5 pixels, a spatial resolution is 3.35 μm×3.35 μm, a standard deviation of the temperature is ±0.0938° C. and a standard deviation of the emission intensity is ±0.14. From these results, it can be seen that when the temperature field is measured by averaging an image by units of 5×5 pixels, it is possible to precisely measure the temperature field although the spatial resolution is lower than when the temperature field is measured by units of 1×1 pixel.

As described above, according to the invention, since the temperature field is measured by averaging the image of fluorescence emission intensity, which is caused by fluorescent dye coated on the surface of the micro device, by units of a plurality of pixels, it is possible to correct the deviation of temperature between each of the pixels and the ensuing deviation of emission intensity, and thus to perform a precise temperature-field measurement.

In addition, according to the invention, the fluorescent dye mixture, which is coated on the surface of the micro device, is composed by a composition ratio capable of obtaining the highest emission intensity, so that the temperature-field measurement can be easily performed.

Although the preferred embodiment of the present invention has been shown and described, it will be appreciated by those skilled in the art that changes may be made in theses embodiments without departing from the principles and spirit of the invention, scope of which is defined in the claims and their equivalents.

What is claimed is:

1. A temperature measuring method for measuring a temperature field on a micro device surface, comprising steps of:
(a) coating a mixture of fluorescent dye on a surface of the micro device;
(b) heating the micro device with a calibration heater;
(c) acquiring an emission intensity image of the mixture with a camera by illuminating the surface of the micro device with a light;
(d) averaging the emission intensity image by units of a plurality of pixels;
(e) calculating a temperature calibration curve indicating a change of the emission intensity with respect to the temperature, from the image averaged by units of a plurality of pixels; and
(f) removing the calibration heater, acquiring an emission intensity image by actually driving the micro device, and converting the acquired emission intensity image into a temperature using the temperature calibration curve.

2. The method according to claim 1, further comprising a step of acquiring a plurality of the emission intensity images at each specific temperature and averaging them between the steps (c) and (d).

3. The method according to claim 2, wherein 200 images are averaged at each specific temperature.

4. The method according to claim 1, wherein in the step (d), the emission intensity image is averaged by units of 5×5 pixels.

5. The method according to claim 1, further comprising a step of dividing the image averaged by units of a plurality of pixels by an emission intensity image obtained at room temperature, between the steps (d) and (e).

6. The method according to claim 2, wherein in the step (d), the emission intensity image is averaged by units of 5×5 pixels.

7. The method according to claim 6, further comprising a step of dividing the image averaged by units of 5×5 pixels by an emission intensity image obtained at room temperature, between the steps (d) and (e).

8. The method according to claim 1, wherein the temperature calibration curve is calculated at each point on the surface of the micro device.

9. The method according to claim 1, wherein the fluorescent dye mixture comprises fluorescent dye, photoresist, thinner, and acetone.

10. The method according to claim 9, wherein the fluorescent dye is rhodamine B.

11. The method according to claim 10, wherein the photoresist is SU8 photoresist.

12. The method according to claim 9, wherein the fluorescent dye mixture comprises about 0.01 g of fluorescent dye, about 5 ml of photoresist, about 2.5 ml of thinner, and about 10 ml of acetone.

13. The method according to claim 12, wherein the fluorescent dye is rhodamine B and the photoresist is SU8 photoresist.

14. The method according to claim 1, wherein the step (f) comprises steps of:
(g) acquiring the emission intensity image of the fluorescent dye mixture according to the actual operation of the micro device;
(h) averaging the image obtained from the step (g) by units of a plurality of pixels;
(i) dividing the image obtained from the step (h) by an emission intensity image at room temperature; and
(j) calculating an emission intensity from the image obtained in the step (i) and converting the calculated emission intensity into a temperature using the calibration curve.

15. The method according to claim 14, wherein in the step (h), the image obtained from the step (g) is averaged by units of 5×5 pixels.

16. The method according to claim 1, wherein the micro device is a micro heater.

17. A temperature measuring method for measuring a temperature field on a micro device surface, comprising steps of:
(a) coating a mixture of fluorescent dye on a surface of the micro device;
(b) heating the micro device with a calibration heater;
(c) acquiring an emission intensity image of the mixture with a camera by illuminating the surface of the micro device with a light;
(d) obtaining a plurality of the emission intensity images at each specific temperature and averaging them;
(e) averaging the image obtained in the step (d) by units of a plurality of pixels;
(f) dividing the image obtained in the step (e) by an emission intensity image at room temperature;
(g) calculating a temperature calibration curve indicating a change of the emission intensity with respect to the temperature, from the image obtained from the step (f);
(h) removing the calibration heater, and acquiring an emission intensity image of the fluorescent dye mixture, caused by actually driving the micro device,
(i) averaging the image obtained in the step (h) by units of a plurality of pixels;
(j) dividing the image obtained in the step (i) by the emission intensity image at room temperature; and
(k) calculating an emission intensity from the image obtained in the step (j) and converting the calculated emission intensity into a temperature using the temperature calibration curve.

18. The method according to claim 17, wherein in the step (d), 200 emission intensity images are obtained at each specific temperature and averaged.

19. The method according to claim 17, wherein in the step (e), the image obtained in the step (d) is averaged by units of 5×5 pixels.

20. The method according to claim 19, wherein in the step (i), the image obtained in the step (h) is averaged by units of 5×5 pixels.
